(19) United States
(12) Patent Application Publication
(10) Pub. No.: US 2018/0197207 A1
(43) Pub. Date: Jul. 12, 2018

(54) SYSTEMS AND METHODS FOR IDENTIFYING POLITICALLY INFLUENTIAL USERS

(71) Applicant: Facebook, Inc., Menlo Park, CA (US)

(72) Inventor: Monica Lee, San Francisco, CA (US)

(21) Appl. No.: 15/403,808

(22) Filed: Jan. 11, 2017

(51) Int. Cl. G06Q 30/02; G06Q 50/00

(52) U.S. Cl. CPC G06Q 30/0269; G06Q 50/01; G06Q 30/0201

(57) ABSTRACT

Systems, methods, and non-transitory computer-readable media can determine a plurality of politically engaged users based on political engagement criteria. A plurality of influential users is determined based on shared content influence criteria. A plurality of politically influential users is determined by determining users that are in both the plurality of politically engaged users and the plurality of influential users. An advertisement is provided to at least a portion of the plurality of politically influential users.

### FIELD OF THE INVENTION

The present technology relates to the field of social networks. More particularly, the present technology relates to identifying politically influential users.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

In some instances, advertisements can be presented to users of the social network. Advertisements may include various content items, such as text, images, or videos. Advertisements may also be linked to various content items, such as websites, for example. Typically, the advertisements presented to a user can be tailored, for example, based on the interests and/or preferences of the user.

### SUMMARY

Various embodiments of the present disclosure can include systems, methods, and non-transitory computer readable media configured to determine a plurality of politically engaged users based on political engagement criteria. A plurality of influential users is determined based on shared content influence criteria. A plurality of politically influential users is determined by determining users that are in both the plurality of politically engaged users and the plurality of influential users. An advertisement is provided to at least a portion of the plurality of politically influential users.

In an embodiment, the shared content influence criteria comprise sharing frequency criteria and user engagement criteria.

In an embodiment, the determining the plurality of influential users comprises ranking a plurality of users based on a number of shared content items posted in a period of time to create a sharing frequency ranking. The sharing frequency criteria comprise a sharing frequency ranking threshold.

In an embodiment, the determining the plurality of influential users comprises, for each user of a social networking system, calculating, for each shared content item posted by the user within a period of time, a z-score based on a number of engagements received by the user for the shared content item and an average number of engagements received by other users on the social networking system for the shared content item.

In an embodiment, the determining the plurality of influential users further comprises: for each user of the social networking system, calculating a user engagement score based on z-scores for all shared content items posted by the user within the period of time. The user engagement criteria comprise a user engagement score ranking threshold.

In an embodiment, each of the plurality of politically influential users is associated with a political ideology based on a political ideology machine learning model.

In an embodiment, a selection of a first political ideology is received from an advertiser. The providing the advertisement to at least a portion of the plurality of politically influential users comprises providing the advertisement to politically influential users associated with the first political ideology

In an embodiment, the plurality of politically engaged users are determined based on a political engagement machine learning model.

In an embodiment, the determining the plurality of politically engaged users based on political engagement criteria comprises, for each user of a social networking system, making a political engagement determination based on pages followed by the user.

In an embodiment, the determining the plurality of politically engaged users based on political engagement criteria comprises: for each user of a social networking system, making a political engagement determination based on content posts posted and/or engaged by the user.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a politically influential user module, according to an embodiment of the present disclosure.

FIG. 2 illustrates an example political influence module, according to an embodiment of the present disclosure.

FIG. 3 illustrates an example political engagement module, according to an embodiment of the present disclosure.

FIG. 4 illustrates an example shared content influence module, according to an embodiment of the present disclosure.

FIG. 5 illustrates an example method associated with identifying politically influential users, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Identifying Politically Influential Users

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

In some instances, advertisements can be presented to users of the social network. Advertisements may include various content items, such as text, images, or videos. Advertisements may also be linked to various content items, such as websites, for example. Typically, the advertisements presented to a user can be tailored, for example, based on the interests and/or preferences of the user.

Political entities, such as politicians, political campaigns, and/or their supporters, may present political advertisements to users on a social networking system. Such political advertisements are typically presented in an attempt to get users to support a particular candidate or cause. Advertisers will generally pay a fee for an advertisement to be presented to particular users or particular groups of users on a social networking system. Users of the social networking system can be provided with the ability to interact with an advertisement by, for example, sharing the advertisement with other users. Sharing of an advertisement represents a potential benefit for the advertiser, as the advertiser can pay for presentation of an advertisement to a first group of users, and then the advertisement can be presented to many more users, including users that are not in the first group of users, if the users that are presented with the advertisement share the advertisement with other users. As such, advertisers, such as political entities, can get more value by presenting advertisements to users that go on to share their advertisements with a large number of other users. However, it can be a challenge to identify users that will share advertisements with a large number of other users. Furthermore, even if users share advertisements, other users may ignore those shared advertisements if, for example, the user sharing the advertisements is not credible or respected.

Therefore, an improved approach can be beneficial for overcoming these and other disadvantages associated with conventional approaches. Based on computer technology, the disclosed technology can identify politically influential users on a social networking system. Political advertisements can be presented to politically influential users with the goal that the politically influential users will share the political advertisements with other users on the social networking system. In certain embodiments, politically influential users can be determined based on determining users that are both politically engaged and influential. Users that are politically engaged may have a higher likelihood of sharing political advertisements, while influential users may have a higher likelihood of having their content posts engaged by other users. As such, users that are both politically engaged and influential are more likely to share political advertisements and to have those shared political advertisements be engaged by other users. In various embodiments, machine learning techniques can be applied to identify politically engaged users. For example, in certain embodiments, for a given user, a political engagement determination may be made based on pages followed by the user and/or content posts posted by or engaged by the user. In various embodiments, influential users can be identified based on shared content information. For example, shared content information can include the frequency with which a user shares content items posted by other users. In another example, shared content information can also include the likelihood that other users will engage with content items shared by the user (i.e., shared content items).

By identifying users that are politically engaged and are influential, a group of politically influential users can be identified. Political advertisements can then be provided to politically influential users. Political advertisements will generally appeal to users of a particular political ideology. For example, a political advertisement in support of a liberal candidate or a liberal cause will generally appeal to more liberal users. Similarly, a political advertisement in support of a conservative candidate or a conservative cause will generally appeal to more conservative users. In certain embodiments, machine learning techniques can be used to group users based on political ideology such that each politically influential user can be associated with a particular political ideology. In this way, political advertisements can be presented to politically influential users of a particular political ideology.

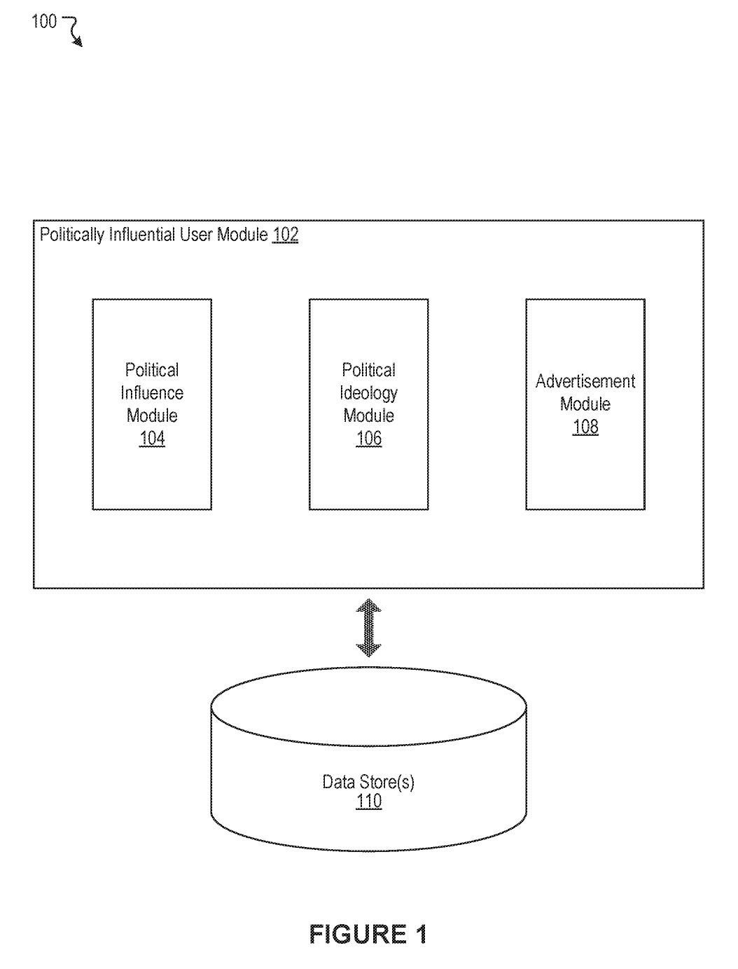

FIG. 1 illustrates an example system 100 including an example politically influential user module 102 configured to identify politically influential users, according to an embodiment of the present disclosure. In certain embodiments, a set of politically influential users can be determined based on political influence criteria. In various embodiments, political influence criteria can include political engagement criteria and shared content influence criteria. Machine learning techniques can be applied to determine politically engaged users based on the political engagement criteria. For example, a user can be identified as a politically engaged user based on the pages followed by the user on the social networking system and/or based on the number of political posts posted by and/or engaged by the user. Influential users can be identified based on the shared content influence criteria. Influential users can include users that (1) share a large amount of content (i.e., post a lot of shared content items) and (2) have high levels of user engagement on their shared content items. Users that are identified as both politically engaged (i.e., satisfy political engagement criteria) and influential (i.e., satisfy shared content influence criteria) can be determined to be politically influential users. The set of politically influential users can also be grouped based on political ideology such that advertisements can be presented to politically influential users of a particular political ideology. Machine learning techniques can be utilized to automatically determine a user's political ideology based on political ideology criteria, including, for example, the user's connections on a social networking system and/or the pages followed by the user on the social networking system.

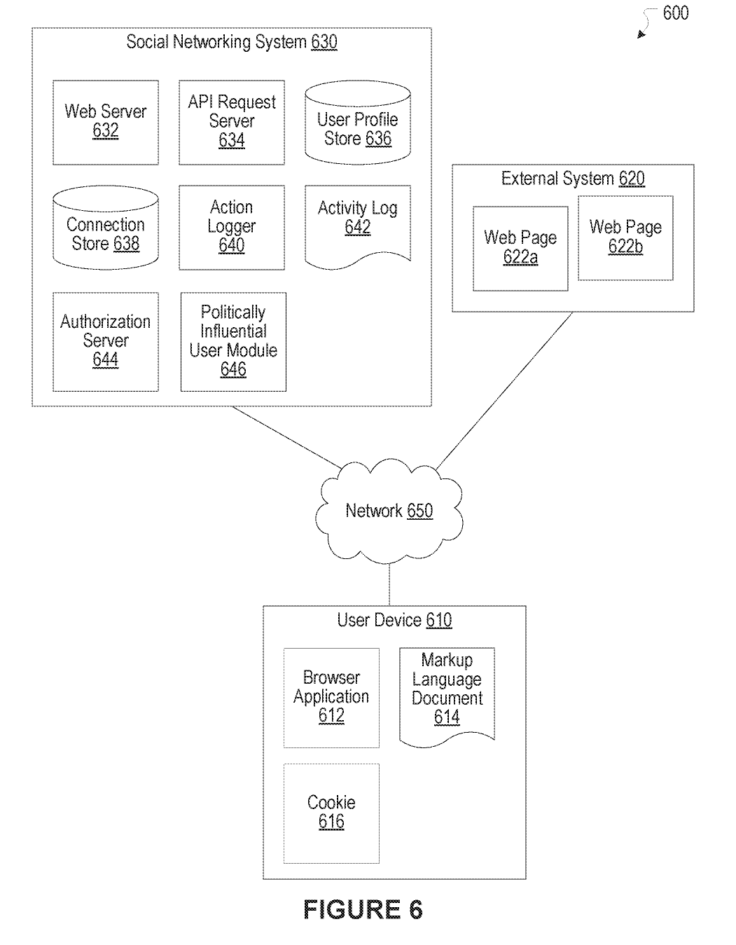

The politically influential user module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the politically influential user module 102 can be implemented, in part or in whole, as software running on one or more computing devices or systems, such as on a server computing system or a user (or client) computing system. For example, the politically influential user module 102 or at least a portion thereof can be implemented as or within an application (e.g., app), a program, or an applet, etc., running on a user computing device or a client computing system, such as the user device 610 of FIG. 6. In another example, the politically influential user module 102 or at least a portion thereof can be implemented using one or more computing devices or systems that include one or more servers, such as network servers or cloud servers. In some instances, the politically influential user module 102 can, in part or in whole, be implemented within or configured to operate in conjunction with a social networking system (or service), such as the social networking system 630 of FIG. 6. It should be understood that there can be many variations or other possibilities.

As shown in the example of FIG. 1, the politically influential user module 102 can include a political influence module 104, a political ideology module 106, and an advertisement module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details.

The politically influential user module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the politically influential user module 102. For example, the data store 110 can store historical social network engagement information, shared content item metrics, political engagement criteria, political engagement scores, political ideology information, one or more machine learning models, and the like, as described in greater detail herein. It is contemplated that there can be many variations or other possibilities.

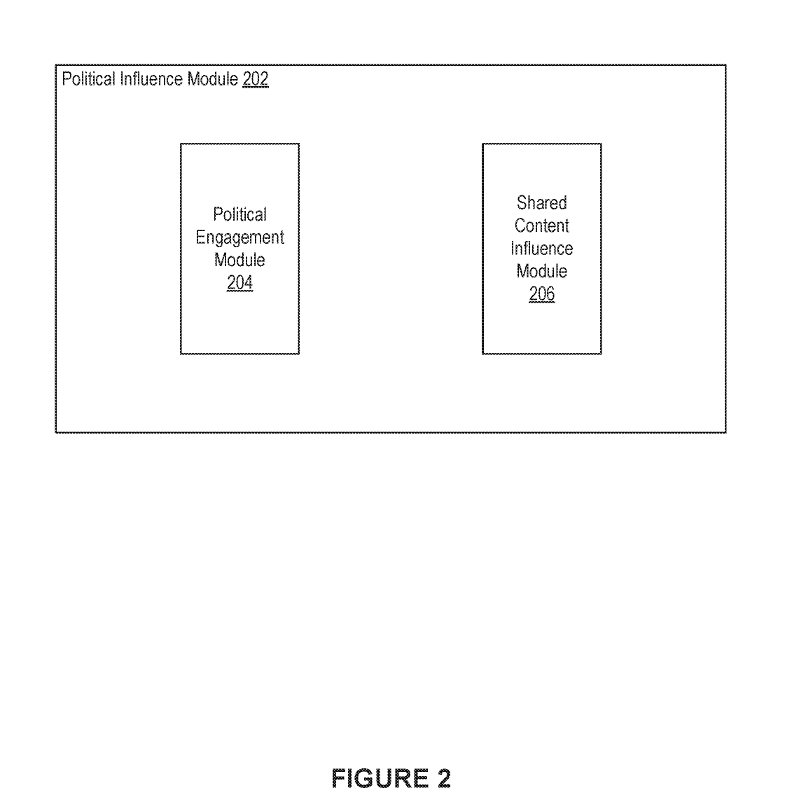

The political influence module 104 can be configured to identify one or more politically influential users based on political influence criteria. In various embodiments, politically influential users can include users that are identified as being both politically engaged (based on political engagement criteria) and influential (based on shared content influence criteria). Machine learning techniques can be applied to determine politically engaged users based on political engagement criteria. Politically engaged users can be identified based on the pages a user follows and/or the types of content posts posted by or engaged by the user. Influential users can be identified based on shared content influence criteria. In certain embodiments, share content influence criteria can include sharing frequency criteria indicative of a frequency with which a user shares content items, and user engagement criteria indicative of how much user engagement a user's shared content items receive. Users with high sharing frequency and high user engagement on shared content items can be identified as influential users. Users that are both politically engaged and influential can be identified as politically influential users. Functionality of the political influence module 104 is described in greater detail herein with reference to FIGS. 2-4.

The political ideology module 106 can be configured to associate users with a particular political ideology based on political ideology criteria. In certain embodiments, machine learning techniques can be utilized to associate users with a particular political ideology of a plurality of political ideologies. For example, a political ideology machine learning model can be trained to classify users into a political ideology group, e.g., very conservative, conservative, moderate, liberal, or very liberal. In various embodiments, the political ideology machine learning model can be trained based on users of a social networking system that self-report their political ideology. Once trained, the political ideology machine learning model can be configured to classify a user into a particular political ideology group based on the user's connections on a social networking system (e.g., if the user has a large number of connections that self-report a particular political ideology are likely to have a similar political ideology) and/or based on the pages followed by the user on the social networking system (e.g., if the user follows pages that have a high proportion of users that self-report a particular political ideology, the user is likely to have a similar political ideology). In various embodiments, the political ideology machine learning model can be configured to calculate a political ideology score for each user that is indicative of the user's political ideology. For example, the political ideology score can be a number between −2 and 2, where a political ideology score of −2 (or approximately −2) is associated with a very conservative political ideology, a political ideology score of −1 (or approximately −1) is associated with a conservative political ideology, a political ideology score of 0 (or approximately 0) is associated with a moderate political ideology, a political ideology score of 1 (or approximately 1) is associated with a liberal political ideology, and a political ideology score of 2 (or approximately 2) is associated with a very liberal political ideology.

In certain embodiments, a liberal influencers cluster (or group) and a conservative influencers cluster (or group) can be generated. The liberal influencers cluster can include politically influential users that have been identified as being liberal (i.e., liberal or very liberal), and the conservative influencers cluster can include politically influential users that have been identified as being conservative (i.e., conservative or very conservative). In certain embodiments, the various political influence thresholds and criteria discussed herein (e.g., political engagement criteria, sharing frequency criteria, user engagement criteria, etc.) can differ for liberal users and conservative users such that the liberal influencers cluster and the conservative influencers cluster each contain an approximately equal number of users.

The advertisement module 108 can be configured to present an advertisement to politically influential users. In certain embodiments, an advertiser can be provided with an interface in which the advertiser can select an option to send an advertisement to politically influential users. In various embodiments, the advertiser can also be given the ability to select one or more political ideologies such that a given advertisement will be sent to politically influential users associated with the one or more political ideologies selected by the advertiser. For example, a political campaign for a candidate may choose to send a first advertisement to liberal and very liberal politically influential users, a second advertisement to moderate politically influential users, and a third advertisement to conservative politically influential users. The content of each advertisement can be tailored to the intended audience.

FIG. 2 illustrates an example political influence module 202 configured to identify political influential users based on political influence criteria, according to an embodiment of the present disclosure. In some embodiments, the political influence module 104 of FIG. 1 can be implemented as the example political influence module 202. As shown in FIG. 2, the political influence module 202 can include a political engagement module 204 and a shared content influence module 206.

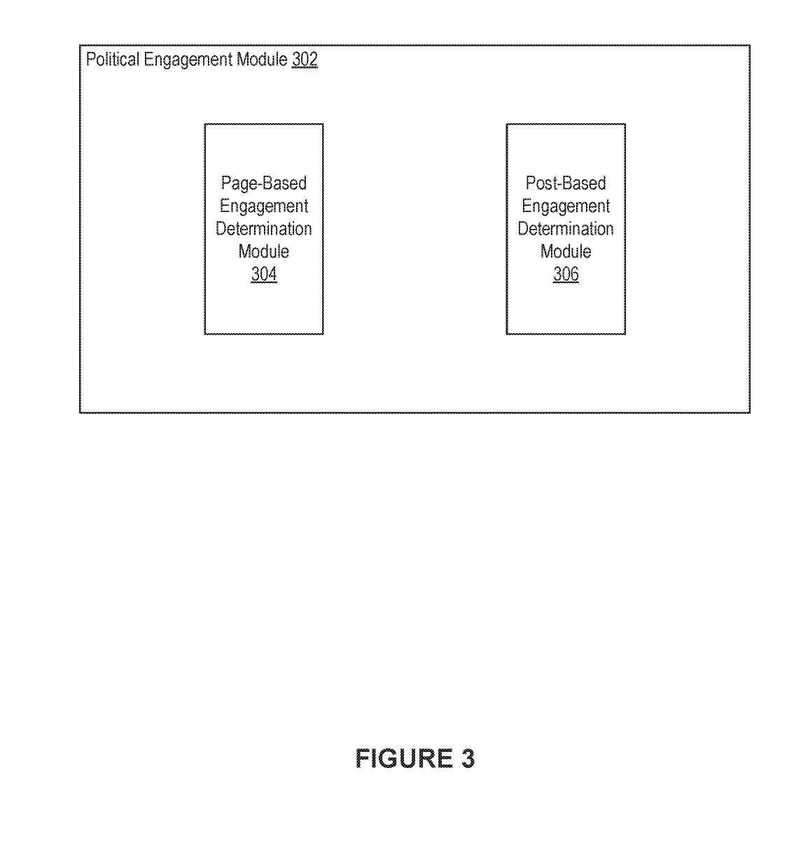

The political engagement module 204 can be configured to identify politically engaged users based on political engagement criteria. Politically engaged users may be more likely to share political advertisements. In certain embodiments, machine learning techniques can be utilized to identify politically engaged users. In certain embodiments, a political engagement machine learning model can be trained to make a political engagement determination for each user based on pages followed by the user on a social networking system. For example, a user that follows a large number of political pages may be determined to be politically engaged. In certain embodiments, the political engagement machine learning model can be trained to make a political engagement determination for each user based on the content posts that the user posts on a social networking system and/or based on content posts that the user engages with on the social networking system. For example, a user that posts a large number of political content posts, or engages with a large number of political content posts, can be identified as a politically engaged user. The political engagement module 204 is described in greater detail with reference to FIG. 3.

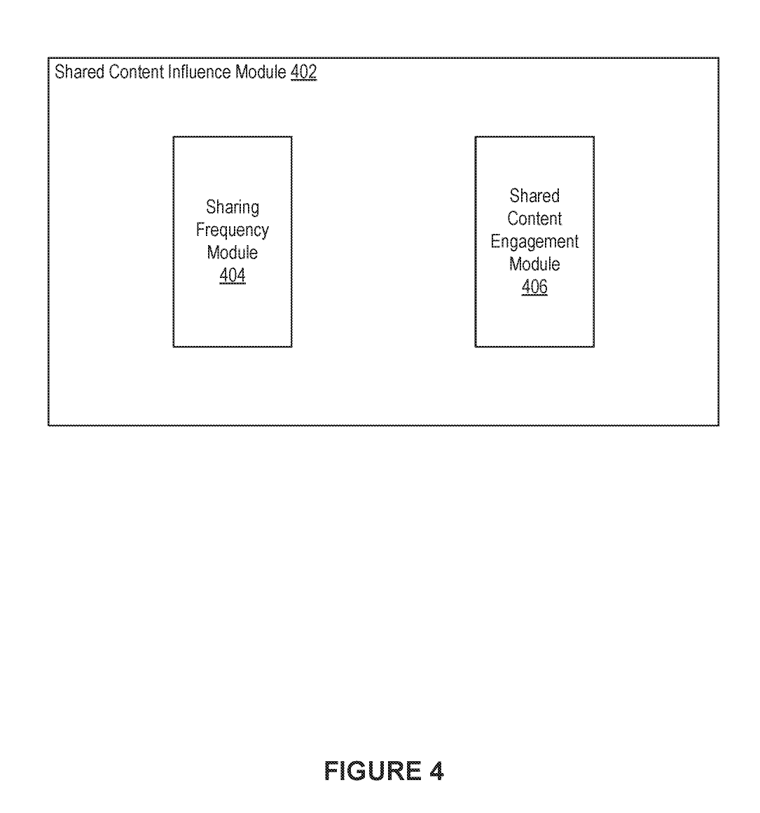

The shared content influence module 206 can be configured to identify one or more influential users based on shared content influence criteria. Influential users may be more likely to share content posts, and also may be more likely to have their shared content items viewed and/or engaged by other users on a social networking system. In certain embodiments, shared content influence criteria can include sharing frequency criteria, and user engagement criteria. Sharing frequency criteria can be used to identify users that share a large number of content posts, and user engagement criteria can be used to identify users that, when they share content, have high levels of engagement by other users. Users that satisfy both the sharing frequency criteria and the user engagement criteria can be identified as influential users. The shared content influence module 206 is described in greater detail with reference to FIG. 4.

FIG. 3 illustrates an example political engagement module 302 configured to identify politically engaged users based on political engagement criteria, according to an embodiment of the present disclosure. In some embodiments, the political engagement module 204 of FIG. 2 can be implemented as the example political engagement module 302. As shown in FIG. 3, the political engagement module 302 can include a page-based engagement determination module 304 and a post-based engagement determination module 306.

The page-based engagement determination module 304 can be configured to determine whether or not a user is politically engaged (i.e., make a political engagement determination for the user) based on pages followed by the user on the social networking system. In certain embodiments, a user engagement machine learning model can be trained to make a political engagement determination for a user based on pages followed by the user on the social networking system.

In certain embodiments, pages on a social networking system may be assigned a page political engagement score. For example, the page political engagement score can be a value between 0 and 1, with 0 indicating zero political engagement, and 1 indicating high political engagement. A particular page's page political engagement score can be determined based on the followers of the page. In certain embodiments, the page political engagement score for a page can be calculated based on the number and/or ratio of users that follow the page that have indicated on the social networking system that they voted in the previous presidential election. Users can indicate on the social networking system that they voted in the previous presidential election by, for example, posting a content post stating that they voted, or utilizing a feature on the social networking system to announce that they voted.

Consider the example of five users, Users A, B, C, D, and E. Users A and B have indicated on the social networking system that they voted in the previous presidential election, whereas Users C, D, and E have not. If Page A is followed by Users A and B, but not C, D, and E, Page A could have a page political engagement score of 1, since all of its followers have indicated that they voted in the previous presidential election. If Page B is followed by Users C, D, and E, but not Users A and B, then Page B may have a page political engagement score of 0, since none of its followers have indicated that they voted in the previous presidential election. If Page C is followed by Users B and C, but not Users A, D, and E, then Page C can have a page political engagement score of 0.5, since half of Page C's followers indicated that they voted in the previous presidential election.

A particular user's level of political engagement can be determined based on the page political engagement scores of the pages followed by the user. For example, certain pages on a social networking system that satisfy a page political engagement score threshold can be tagged or identified as politically engaged pages. If the user follows a threshold number of politically engaged pages, and/or if a certain ratio of the user's followed pages are politically engaged pages, the user can be identified as a politically engaged user.

The post-based engagement determination module 306 can be configured to identify politically engaged users based on content posts posted by the user to the social networking system and/or content posts engaged by the user on the social networking system. In certain embodiments, certain content posts on a social networking system can be classified as political content posts. For example, content posts may be classified as political content posts based on natural language processing. A user can be identified as a politically engaged user if, for example, the user has posted and/or engaged (e.g., liked, commented on, and/or shared) a threshold number of political content posts.

FIG. 4 illustrates an example shared content influence module 402 configured to identify influential users based on shared content influence criteria, according to an embodiment of the present disclosure. In some embodiments, the shared content influence module 206 of FIG. 2 can be implemented as the example shared content influence module 402. As shown in FIG. 4, the shared content influence module 402 can include a sharing frequency module 404 and a shared content engagement module 406.

The sharing frequency module 404 can be configured to identify users that frequently share content based on sharing frequency criteria. In certain embodiments, users of a social networking system can be ranked based on the number of times they posted shared content items over a period of time to create a sharing frequency ranking. The sharing frequency criteria can include a sharing frequency ranking threshold, such that a user must satisfy the sharing frequency ranking threshold to be identified as a user that frequently shares content, and, in turn, remain eligible to be identified as an influential user. For example, a certain number and/or percentage of users can be identified as users that frequently share content based on the ranking, e.g., the top n users or the top n% of users can be selected based on the sharing frequency ranking.

The shared content engagement module 406 can be configured to identify users with high shared content engagement based on user engagement criteria. If a user tends to have large numbers of other users engage with his or her shared content items (i.e., a content item that was posted by another user and then shared by the user), that can generally be considered a positive signal that the user is influential among his or her social circle.

In order to identify users with high shared content engagement, each shared content item that is shared on a social networking system can be analyzed individually. This is to account for the fact that certain shared content items have a higher propensity for engagement than others. In order to account for these differences, engagement metrics can be determined for each shared content item on a social networking system. For each instance in which a shared content item is shared by users on a social networking system, a number of engagements (e.g., number of likes+number of comments) can be recorded. This engagement information can be reviewed to determine a range of engagements (lowest number of engagements and highest number of engagements) for the shared content item and/or an average number of engagements for that particular shared content item.

For example, consider two different shared content items: Link A (which provides a link to a first website) and Link B (which provides a link to a second website). Link A and Link B may have been shared by thousands of users on the social networking system. When Link A is shared by users, the fewest number of engagements the shared content item has received is 5 engagements, the greatest number of engagements the shared content item has received is 500 engagements, and the average number of engagements the shared content item has received is 280 engagements. When Link B is shared by users, the fewest number of engagements the shared content item has received is 0 engagements, the greatest number of engagements the shared content item has received is 250 engagements, and the average number of engagements the shared content item has received is 50 engagements. The engagement information for these two different shared content items indicate that Link A has a greater propensity for engagement than Link B. Now, consider an example scenario in which a first user, User 1, shares Link A, and gets 250 engagements, and a second user, User 2, shares Link B and also gets 250 engagements. It is actually more impressive, and a greater indication of influence, that User 2 got the same number of engagements sharing Link B as User 1 got sharing Link A. In fact, User 1 received a below average number of engagements on Link A, whereas User 2 received the highest number of engagements on Link B that has ever been received. By normalizing for differences in the propensity of shared content items to be engaged by other users, a user's influence can more accurately be measured.

In certain embodiments, in order to determine users with high shared content engagement, the number of engagements received by a user for a shared content item (i.e., a current user's engagements) can be compared to the average number of engagements when the shared content item has been shared by other users (i.e., the average engagements). The current user's engagements for the shared content item can be compared to the average engagements for the shared content item to calculate a z-score for the shared content item indicative of how many standard deviations above or below the average engagements the current user's engagements is. A high z-score indicates that the user received a significantly greater number of engagements compared to other users that shared the shared content item, whereas a low, negative z-score indicates that the user received a significantly smaller number of engagements compared to the average. The z-scores for all of a user's shared content items posted over a period of time can be aggregated (e.g., averaged or summed) to calculate a user engagement score. Users can be ranked based on user engagement scores. A user engagement score threshold can be implemented to identify users having high shared content engagement. For example, the top n users based on shared content engagement score ranking, or the top n% of users based on shared content engagement score ranking, can be identified as users having high shared content engagement.

Users that satisfy both the sharing frequency criteria and the user engagement criteria can be identified as influential users. Users that are both politically engaged and influential can be identified as politically influential users.

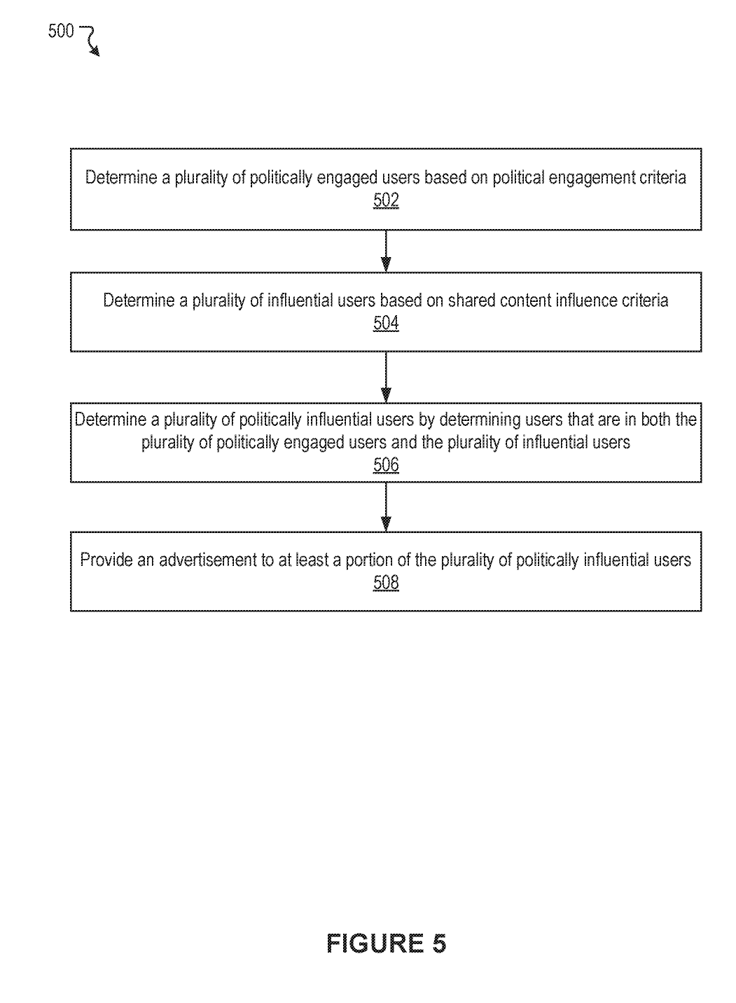

FIG. 5 illustrates an example method 500 associated with determining a plurality of politically influential users, according to an embodiment of the present disclosure. It should be appreciated that there can be additional, fewer, or alternative steps performed in similar or alternative orders, or in parallel, based on the various features and embodiments discussed herein unless otherwise stated.

At block 502, the example method 500 can determine a plurality of politically engaged users based on political engagement criteria. At block 504, the example method 500 can determine a plurality of influential users based on shared content influence criteria. At block 506, the example method 500 can determine a plurality of politically influential users by determining users that are in both the plurality of politically engaged users and the plurality of influential users. At block 508, the example method 500 can provide an advertisement to at least a portion of the plurality of politically influential users. Other suitable techniques that incorporate various features and embodiments of the present technology are possible.

It is contemplated that there can be many other uses, applications, features, possibilities, and variations associated with various embodiments of the present technology. For example, users can choose whether or not to opt-in to utilize the present technology. The present technology also can ensure that various privacy settings, preferences, and configurations are maintained and can prevent private information from being divulged. In another example, various embodiments of the present technology can learn, improve, and be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and provides users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a politically influential user module 646. The politically influential user module 646 can, for example, be implemented as the politically influential user module 102, as discussed in more detail herein. As discussed previously, it should be appreciated that there can be many variations or other possibilities. For example, in some embodiments, one or more functionalities of the politically influential user module 646 can be implemented in the user device 610.

### Hardware Implementation

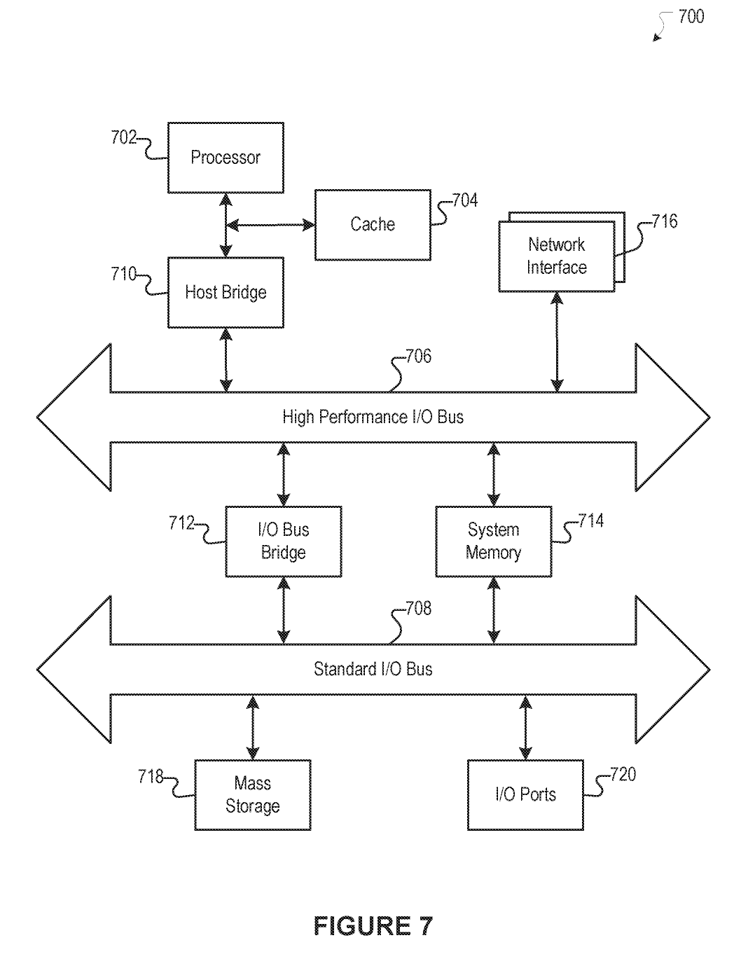

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
determining, by a computing system, a plurality of politically engaged users based on political engagement criteria;
determining, by the computing system, a plurality of influential users based on shared content influence criteria;
determining, by the computing system, a plurality of politically influential users by determining users that are in both the plurality of politically engaged users and the plurality of influential users; and
providing, by the computing system, an advertisement to at least a portion of the plurality of politically influential users.

2. The computer-implemented method of claim 1, wherein the shared content influence criteria comprise sharing frequency criteria and user engagement criteria.

3. The computer-implemented method of claim 2, wherein the determining the plurality of influential users comprises:
ranking a plurality of users based on a number of shared content items posted in a period of time to create a sharing frequency ranking, wherein
the sharing frequency criteria comprise a sharing frequency ranking threshold.

4. The computer-implemented method of claim 2, wherein the determining the plurality of influential users comprises:
for each user of a social networking system,
calculating, for each shared content item posted by the user within a period of time, a z-score based on a number of engagements received by the user for the shared content item and an average number of engagements received by other users on the social networking system for the shared content item.

5. The computer-implemented method of claim 4, wherein the determining the plurality of influential users further comprises:
for each user of the social networking system,
calculating a user engagement score based on z-scores for all shared content items posted by the user within the period of time, and further wherein
the user engagement criteria comprise a user engagement score ranking threshold.

6. The computer-implemented method of claim 1, further comprising associating each of the plurality of politically influential users with a political ideology based on a political ideology machine learning model.

7. The computer-implemented method of claim 6, further comprising receiving a selection of a first political ideology from an advertiser, wherein
the providing the advertisement to at least a portion of the plurality of politically influential users comprises providing the advertisement to politically influential users associated with the first political ideology.

8. The computer-implemented method of claim 1, wherein the plurality of politically engaged users are determined based on a political engagement machine learning model.

9. The computer-implemented method of claim 8, wherein the determining the plurality of politically engaged users based on political engagement criteria comprises:
for each user of a social networking system,
making a political engagement determination based on pages followed by the user.

10. The computer-implemented method of claim 8, wherein the determining the plurality of politically engaged users based on political engagement criteria comprises:
for each user of a social networking system,
making a political engagement determination based on content posts posted and/or engaged by the user.

11. A system comprising:
at least one processor; and
a memory storing instructions that, when executed by the at least one processor, cause the system to perform a method comprising:
determining a plurality of politically engaged users based on political engagement criteria;
determining a plurality of influential users based on shared content influence criteria;
determining a plurality of politically influential users by determining users that are in both the plurality of politically engaged users and the plurality of influential users; and
providing an advertisement to at least a portion of the plurality of politically influential users.

12. The system of claim 11, wherein the shared content influence criteria comprise sharing frequency criteria and user engagement criteria.

13. The system of claim 12, wherein the determining the plurality of influential users comprises:
ranking a plurality of users based on a number of shared content items posted in a period of time to create a sharing frequency ranking, wherein
the sharing frequency criteria comprise a sharing frequency ranking threshold.

14. The system of claim 12, wherein the determining the plurality of influential users comprises:
for each user of a social networking system,
calculating, for each shared content item posted by the user within a period of time, a z-score based on a number of engagements received by the user for the shared content item and an average number of engagements received by other users on the social networking system for the shared content item.

15. The system of claim 14, wherein the determining the plurality of influential users further comprises:
for each user of the social networking system,
calculating a user engagement score based on z-scores for all shared content items posted by the user within the period of time, and further wherein
the user engagement criteria comprise a user engagement score ranking threshold.

16. A non-transitory computer-readable storage medium including instructions that, when executed by at least one processor of a computing system, cause the computing system to perform a method comprising:
determining a plurality of politically engaged users based on political engagement criteria;
determining a plurality of influential users based on shared content influence criteria;
determining a plurality of politically influential users by determining users that are in both the plurality of politically engaged users and the plurality of influential users; and
providing an advertisement to at least a portion of the plurality of politically influential users.

17. The non-transitory computer-readable storage medium of claim 16, wherein the shared content influence criteria comprise sharing frequency criteria and user engagement criteria.

18. The non-transitory computer-readable storage medium of claim 17, wherein the determining the plurality of influential users comprises:
ranking a plurality of users based on a number of shared content items posted in a period of time to create a sharing frequency ranking, wherein
the sharing frequency criteria comprise a sharing frequency ranking threshold.

19. The non-transitory computer-readable storage medium of claim 17, wherein the determining the plurality of influential users comprises:
for each user of a social networking system,
calculating, for each shared content item posted by the user within a period of time, a z-score based on a number of engagements received by the user for the shared content item and an average number of engagements received by other users on the social networking system for the shared content item.

20. The non-transitory computer-readable storage medium of claim 19, wherein the determining the plurality of influential users further comprises:
for each user of the social networking system,
calculating a user engagement score based on z-scores for all shared content items posted by the user within the period of time, and further wherein
the user engagement criteria comprise a user engagement score ranking threshold.
